(19) United States
(12) Patent Application Publication
(10) Pub. No.: US 2020/0090580 A1
(43) Pub. Date: Mar. 19, 2020

(54) DISPLAY APPARATUS AND CONTROLLING METHOD THEREOF

(71) Applicant: SAMSUNG ELECTRONICS CO., LTD., Suwon-si (KR)

(72) Inventors: Byeongcheol HYEON, Suwon-si (KR); Yonghoon YEO, Suwon-si (KR); Jaehyang LEE, Suwon-si (KR)

(73) Assignee: SAMSUNG ELECTRONICS CO., LTD., Suwon-si (KR)

(21) Appl. No.: 16/560,256

(22) Filed: Sep. 4, 2019

(30) Foreign Application Priority Data
Sep. 14, 2018 (KR) 10-2018-0110193

(51) Int. Cl. G09G 3/32; G09G 5/14

(52) U.S. Cl. CPC G09G 3/32; G09G 5/14; G09G 2360/04; G09G 2310/08; G09G 2300/026; G09G 2330/06

(57) ABSTRACT

A display apparatus is provided. The display apparatus may include a plurality of Light Emitting Diode (LED) modules and a controller configured to obtain a plurality of image signals corresponding to the plurality of LED modules based on an input signal and control each of the plurality of LED modules based on the obtained plurality of image signals. The controller may be configured to delay a phase of the plurality of image signals to control the plurality of image signals to be output to the plurality of LED modules at different timings.

### CROSS-REFERENCE TO RELATED APPLICATIONS

This application is based on and claims priority under 35 U.S.C. § 119 to Korean Patent Application No. 10-2018-0110193, filed on Sep. 14, 2018 in the Korean Intellectual Property Office, the disclosure of which is incorporated by reference herein in its entirety.

### BACKGROUND

### 1. Field

Apparatuses and methods consistent with exemplary embodiment of the present disclosure relate to a display apparatus and a controlling method thereof and more particularly, to a display apparatus for reducing Electro Magnetic Interference (EMI) and a controlling method thereof.

### 2. Description of the Related Art

In general, EMI is generated in the process of a controller, provided in a display apparatus, transmitting a clock signal and high-speed image data to an operation driver of a display module.

To be specific, conventionally, a controller outputs a plurality of clock signals and data signals at the same time (phase) and thus, the high-frequency components generated in the high-frequency area are concentrated in a specific frequency band, thereby increasing the EMI noise.

As such, there is a problem that the clock signals and data signals are damaged by the EMI noise.

### SUMMARY

An aspect of the embodiments relates to providing a display apparatus which reduces EMI noise by delaying the phase of an image signal output from a controller by each display module and a controlling method thereof.

According to an embodiment, a display apparatus may include a plurality of Light Emitting Diode (LED) modules and a controller configured to obtain a plurality of image signals corresponding to the plurality of LED modules based on an input signal and control each of the plurality of LED modules based on the obtained plurality of image signals. The controller may be configured to delay a phase of the plurality of image signals to control the plurality of image signals to be output to the plurality of LED modules at different timings.

The controller may be configured to delay the phase of the plurality of image signals sequentially, and a phase difference between a first image signal output among the plurality of image signals and a last image signal output among the plurality of image signals is within a time interval corresponding to one frame.

The plurality of image signals may include at least one of a clock signal and a data signal.

A phase difference between the plurality of image signals may be obtained based on a time corresponding to one frame and a number of the plurality of LED modules.

The controller may be further configured to delay the phase of the plurality of image signals sequentially by a predetermined time based on an arrangement state of the plurality of LED modules.

The controller may be further configured to transmit a first image signal to a first LED module among the plurality of LED modules, and transmit a second image signal that is delayed by the predetermined time from the first image signal, to a second LED module that is arranged at a greatest distance from the first LED module.

The plurality of LED modules may include a plurality of Micro LED elements.

According to another embodiment, a display system may include a display apparatus comprising a plurality of display modules including a plurality of LED modules, and a plurality of controllers connected to the plurality of display modules, and an image processing apparatus configured to obtain a plurality of image signals corresponding to the plurality of display modules by processing an input image signal, and transmit the obtained signal to the plurality of controllers. Each of the plurality of controllers may be configured to receive, from the image processing apparatus, the plurality of image signals corresponding to each of the plurality of LED modules, and control each of the plurality of LED modules based on the received plurality of image signals.

Each of the plurality of LED modules may include a plurality of Micro LED elements, and the plurality of LED modules may be connected to form at least one of the plurality of display modules.

According to another embodiment, a controlling method of a display apparatus, the method may include obtaining a plurality of image signals corresponding to a plurality of LED modules based on an input signal and controlling each of the plurality of LED modules based on the obtained plurality of image signals, wherein the controlling includes delaying a phase of the plurality of image signals to control the plurality of image signals to be output to the plurality of LED modules at different timings.

The controlling may further include delaying the phase of the plurality of image signals sequentially, and a phase difference between a first image signal output among the plurality of image signals and a last image signal output among the plurality of image signals is within a time interval corresponding to one frame.

The plurality of image signals may include at least one of a clock signal and a data signal.

A phase difference between the plurality of image signals may be obtained based on a time corresponding to one frame and a number of the plurality of LED modules.

The controlling may further include delaying the phase of the plurality of image signals sequentially by a predetermined time based on an arrangement state of the plurality of LED modules.

The controlling may further include transmitting a first image signal to a first LED module among the plurality of LED modules, and transmitting a second image signal that is delayed by the predetermined time from the first image signal, to a second LED module that is arranged at a greatest distance from the first LED module.

The plurality of LED modules may include a plurality of Micro LED elements.

According to the above-described various embodiments, when a controller of a display apparatus transmits an image signal to display modules, by outputting the image signal to each display module at different timings, it is possible to disperse a peak in a frequency area of the image signal, thereby reducing the EMI noise signal.

### BRIEF DESCRIPTION OF THE DRAWINGS

The above and/or other aspects of the present disclosure will be more apparent by describing certain exemplary embodiments of the present disclosure with reference to the accompanying drawings, in which:

FIG. 1 is a schematic view illustrating configuration of a display apparatus according to an embodiment;

FIG. 2 is a block diagram illustrating configuration of a display apparatus according to an embodiment;

FIG. 3 is a block diagram illustrating configuration of a display system according to an embodiment;

FIG. 4 is a schematic view illustrating a phase delay of a plurality of image signals based on the arrangement state of a plurality of LED modules according to an embodiment;

FIGS. 5(a) and 5(b) are schematic views illustrating a phase delay according to an embodiment; and

FIG. 6 is a flowchart provided to explain a controlling method of a display apparatus according to an embodiment.

### DETAILED DESCRIPTION OF EXEMPLARY EMBODIMENTS

Certain exemplary embodiments of the present disclosure will now be described in greater detail with reference to the accompanying drawings.

Terms used in the present disclosure are general terminologies currently widely used in consideration of the configuration and functions of the present disclosure, but may be different depending on the intention of those skilled in the art, a precedent, appearance of new technologies, and the like. Further, in specific cases, terms may be arbitrarily selected. Accordingly, the terms used in the present disclosure should not necessarily be construed as simple names of the terms, but defined based on meanings of the terms and overall context of the present disclosure.

The example embodiments may vary, and may be provided in different example embodiments. Various example embodiments will be described with reference to accompanying drawings. However, this does not necessarily limit the scope of the example embodiments to a specific embodiment. Instead, modifications, equivalents and replacements included in the disclosed concept and technical scope of this specification may be employed. While describing example embodiments, if it is determined that the specific description regarding known technology obscures the gist of the disclosure, the specific description may be omitted.

The terms such as “first,” “second,” and so on, may be used to describe a variety of elements, but the elements should not be limited by these terms. The terms used herein are solely intended to explain specific example embodiments, not to limit the scope of the present disclosure.

Singular forms are intended to include plural forms unless the context clearly indicates otherwise. In the present disclosure, the terms “include” and “comprise” designate the presence of features, numbers, steps, operations, components, elements, or a combination thereof that are written in the specification, but do not exclude the presence or possibility of addition of one or more other features, numbers, steps, operations, components, elements, or a combination thereof.

The expression of ‘at least one of A and B’ may refer to one of ‘A’ or ‘B’ or ‘A and B.’

In the present disclosure, a ‘module’ or a ‘unit’ may perform at least one function or operation and may be implemented by hardware or software or a combination of the hardware and the software. In addition, a plurality of ‘modules’ or a plurality of ‘units’ may be integrated into at least one module and may be at least one processor except for ‘modules’ or ‘units’ that should be realized in a specific hardware.

The example embodiments of the disclosure will be described in greater detail below in a manner that will be understood by one of ordinary skill in the art. However, example embodiments may be realized in a variety of different configurations, and not limited to descriptions provided herein. Also, well-known functions or constructions may not be described in detail. Like numbers refer to like parts throughout the specification.

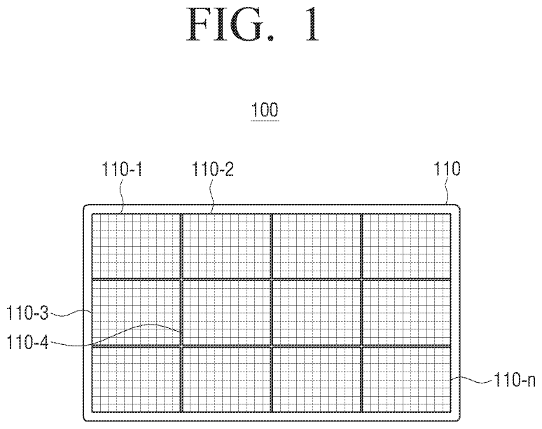

FIG. 1 is a schematic view illustrating configuration of a display apparatus according to an embodiment.

Referring to FIG. 1, a display apparatus 100 according to an embodiment may be implemented in a form where a plurality of LED modules 110-1, 110-2, 110-3, 110-4, . . . 110-n may be physically connected. Here, each of the plurality of LED modules 110-1, 110-2, 110-3, 110-4, . . . 110-n may include a plurality of pixels which may be arranged in the form of matrix. In particular, each of the plurality of LED modules 110-1, 110-2, 110-3, 110-4, . . . 110-n may include a plurality of LED elements. For example, the LED modules may be implemented as LED, Micro LED, organic LED (OLED), or active-matrix OLED (AMOLED).

As illustrated in FIG. 1, the plurality of LED modules 110-1, 110-2, 110-3, 110-4, . . . 110-n may be physically connected to form one display module 110. Hereinafter, one display module 110, where the plurality of LED modules 110-1, 110-2, 110-3, 110-4, . . . 110-n are connected together, will be referred to as a display module or an LED cabinet.

The display apparatus 100 may transmit an image signal to each of the plurality of LED modules 110-1, 110-2, 110-3, 110-4, . . . 110-n in order to display an image, and various example embodiments of reducing EMI which is generated in the process of transmitting an image signal to each LED module will be described in detail with reference to the corresponding drawings.

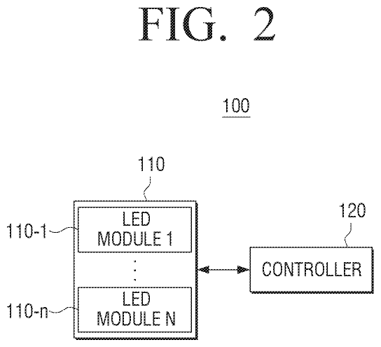

FIG. 2 is a block diagram illustrating configuration of a display apparatus according to an embodiment.

The display module 110 may include a plurality of LED modules 110-1, . . . , 110-n. Here, each of the plurality of LED modules may include a plurality of pixels which may be arranged in the form of matrix. In particular, each of the plurality of LED modules 110-1, . . . , 110-n may be modules including a plurality of LED elements. According to an embodiment, an LED element may be implemented as an RGB LED, and an RGB LED may include all of RED LED, GREEN LED and BLUE RED. In addition, an LED element may be implemented as a micro LED. Here, the micro LED is an LED having the size of 5-100 micrometers, and is a very small light emitting device which emits light by itself without a color filter.

The controller 120 controls the operation of transmitting an image signal to the display module 110.

The controller 120 according to an embodiment may receive image and may be implemented as a Time controller (TCON), which may receive image information and transmit the image information to a driving module of an LED module.

The controller 120 may obtain a plurality of image signals corresponding to the plurality of LED modules 110-1, . . . , 110-n based on an input signal. Here, the input signal may be a signal regarding the input image information. For instance, if the display apparatus 100 is implemented as a cabinet connecting a plurality of LED modules, the input signal may be received from a processor. Alternatively, if the display apparatus 100 is implemented as a TV, the input signal may be received from another processor, for example, a main CPU.

The controller 120 may control an LED driving module to apply driving voltage or driving current in order to drive each LED pixel constituting an LED module. In addition, the LED driving module may display an image corresponding to an image signal on a display screen. The LED driving module may be implemented as an LED driver.

In addition, the image signal may be a signal including at least one of a clock signal and a data signal. In other words, the controller 120 may obtain a clock signal and a data signal corresponding to each of the plurality of LED modules 110-1, . . . , 110-n based on an input signal.

Here, the clock signal is a signal related to time information for controlling the timing of displaying an image corresponding to the data signal, and may be output in the form of a spherical wave. The data signal may be a signal including data regarding an image to be displayed on the display apparatus 100. For instance, the data signal may include pixel values, luminance information, and so on.

The controller 120 may control each of a plurality of LED modules based on a plurality of obtained image signals.

The controller 120 may transmit a clock signal and a data signal to a driving module of each of the plurality of LED modules 110-1, . . . , 110-n. Specifically, the controller 120 may transmit a clock signal to each of the plurality of LED modules 110-1, . . . , 110-n through a clock signal transmission wiring and transmit a data signal to each of the plurality of LED modules 110-1, . . . , 110-n through a data transmission wiring. In other words, the controller 120 may transmit a clock signal and a data signal to the plurality of LED modules 110-1, . . . , 110-n through separate wirings.

However, the present disclosure is not limited thereto, and may implement a clock embedding method where a clock signal and a data signal are transmitted on a single transmission line or a method where a transmission line for transmitting a clocks signal is not needed because only a data signal is encoded and transmitted, and a clock signal may be acquired from the encoded data may be used.

Meanwhile, the controller 120 may transmit a clock signal and a data signal to a plurality of LED modules 110-1, . . . , 110-n simultaneously. In other words, the controller 120 may transmit a data signal along with a clock signal to the plurality of LED modules 110-1, . . . , 110-n. However, this is only an example, and the processor 120 may transmit either one of the two signals first.

The controller 120 may delay phases of a plurality of image signals sequentially to control the plurality of image signals to be output by the plurality of LED modules 110-1, . . . , 110-n at different timings.

According to an embodiment, the controller 120 may sequentially delay the phase of an image signal to be transmitted to each of the plurality of LED modules 110-1, . . . , 110-n by a predetermined time. For instance, in the case of a display module formed of three LED modules, the controller 120 may output the first image signal to the first LED module, the second image signal which may be delayed by a predetermined time to the second LED module, and the third image signal which may be delayed by a predetermined time to the third LED module. Here, the predetermined time for the second image signal and the predetermined time for the third image signal may be the same or different. As such, the controller 120 may output a plurality of image signals to a plurality of LED modules, respectively, at different timings.

Here, the predetermined time, that is, the phase difference between a plurality of image signals, may be obtained based on the time corresponding to one frame and the number of a plurality of LED modules. Specifically, the phase difference between a plurality of image signals may be a value calculated by dividing the time corresponding to one frame by the number of a plurality of LED modules. For instance, if the time corresponding to one frame is 30 ns and there are three LED modules forming the display module 110, the predetermined time may be 30 ns/3, that is, 10 ns. In other words, the controller 120 may transmit the first image signal to the first LED module and transmit the second image signal to the second LED module after 10 ns.

Accordingly, the controller 120 may output an image signal to each LED module at different times and thus, the rising edges in the frequency area due to the transmission of image signals may be dispersed to the maximum, thereby reducing the EMI.

However, the present disclosure is not limited thereto, and the predetermined time may be one of the values which are calculated by dividing the time corresponding to one frame by the number of the plurality of LED modules 110-1, . . . , 110-n.

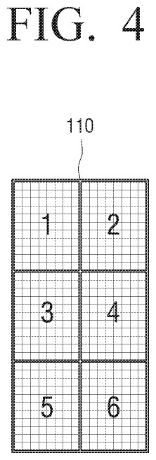

According to an embodiment, the controller 120 may delay the phases of a plurality of image signals by a predetermined time based on the arrangement state of the plurality of LED modules 110-1, . . . , 110-n, which will be described with reference to FIG. 4.

FIG. 4 is a schematic view illustrating a phase delay of a plurality of image signals based on the arrangement state of a plurality of LED modules according to an embodiment.

In FIG. 4, it is assumed that six LED modules form the display module 110. In addition, as illustrated in FIG. 4, six LED modules are given Arabic numbers for convenience of explaining the order of phase delay. For instance, “1” in FIG. 4 refers to the first LED module and “2” refers to the second LED module, and so on.

The controller 120 may delay the phase of an image signal to each LED module in the order of 1, 2, 3, 4, 5, and 6. For instance, if the predetermined time corresponding to the phase difference between a plurality of image signals is 10 ns, the controller 120 may transmit the first LED module to the first image signal and transmit the second image signal to the second LED module after 10 ns. When the phase is delayed in this manner, the time difference between the time when the first image signal is transmitted and the time when the sixth image signal is transmitted may be 50 ns.

According to another embodiment, the controller 120 may transmit the first image signal to the first LED module from among a plurality of LED modules and transmit the second image signal which may be delayed by a predetermined time in comparison with the first image signal, to the module disposed at the greatest distance from the first LED module.

For instance, referring to FIG. 4, the controller 120 may transmit the first image signal to the first LED module and transmit the second image signal which may be delayed by the predetermined time of 10 ns, to the sixth LED module disposed at the greatest distance from the first LED module. Subsequently, the controller 120 may transmit the third image signal which may be delayed by another 10 ns to the second LED module disposed at the greatest distance from the sixth module besides the first LED module. In other words, the controller 120 may transmit a delayed image signal by transmitting an image signal to one LED module and transmit the next image signal which may be delayed by a predetermined time to another LED module disposed at the greatest distance with reference to the corresponding LED module.

As image signals are transmitted based on the greatest distance, the peaks of the image signals in the frequency area may be further dispersed. Thus, in the case of transmitting image signals based on the greatest distance from one display module to another, the degree of reducing the EMI noise may be relatively greater than in the case of transmitting image signals sequentially to adjacent LED modules.

However, the present disclosure is not limited to the above embodiments, and the controller 120 may transmit image signals in the order of the LED modules having even numbers and odd numbers in FIG. 4. For example, the order of transmission may be 1, 3, 5, 2, 4, and 6 or 2, 4, 6, 1, 3, and 6, or may transmit image signals in an arbitrary order. In FIG. 4, it may be assumed that six LED modules form the display module 110, but this is only an example.

The controller 120 may delay the phases of a plurality of image signals sequentially. For example, the phase difference between the first image signal among the plurality of image signals and the last image signal among the plurality of image signals may fall within a time interval corresponding to a single frame.

In other words, the controller 120 may output the last image signal among the plurality of image signals within a time interval corresponding to a single frame. If the image signal which is output for the last time exceeds the time corresponding to one frame, there may be a problem because the frame corresponding to the image signal may be overlapped with the next frame on a display screen. Accordingly, the last image signal among the plurality of image signals to be output should be output within a time interval corresponding to one frame.

Meanwhile, the plurality of LED modules 110-1, . . . , 110-n may be modules including a plurality of Micro LED elements. Here, the Micro LED may be a miniature LED having the size of 10-100 μm, which is about one-tenth the length of a general LED chip and therefore, about one-hundredth the size of the general LED chip.

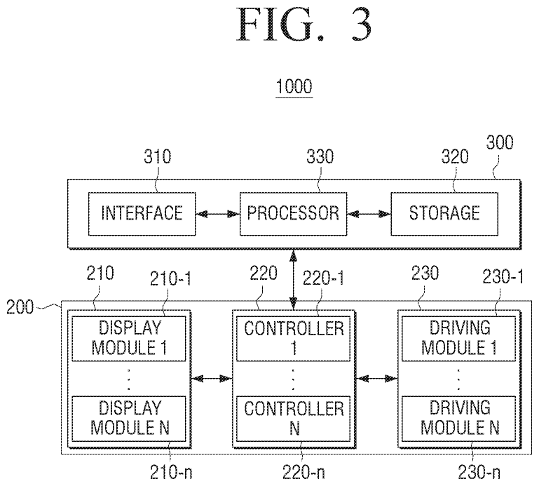

FIG. 3 is a block diagram illustrating configuration of a display system according to an embodiment.

A display system 1000 may comprise a display apparatus 200 and an image processing apparatus 300.

The display apparatus 200 comprises a plurality of display modules 210 and a plurality of controllers 220, and a display driver 230 which drives the plurality of display modules. In other words, the display apparatus 200 in FIG. 3 is a modular display apparatus where a plurality of modules may be connected. The elements of FIG. 3 which are already discussed with reference to FIG. 2 will not be described in detail.

The plurality of display modules 210 may be configured such that, each display module comprising a plurality of LED modules, may be connected to each other.

As such, a display apparatus including a plurality of display modules 210 may be implemented as a Large Format Display (LFD) or the like, and may be used as an outdoor display apparatus, such as an electric sign board.

The plurality of controllers 220 may control the plurality of display modules 210 and the display driver 230. Specifically, the plurality of controllers 220 may transmit an image signal corresponding to each LED module to the driving modules 230-1, . . . , 230-n.

Each of the plurality of controllers 220-1, . . . , 220-n may exist for each of the display modules 210-1, . . . , 210-n.

Each of the plurality of controllers 220 may control a plurality of LED modules by transmitting image signals corresponding to the plurality of LED modules included in the corresponding display modules 210-1, . . . , 210-n to each LED module based on a received signal so that the corresponding images may be displayed.

Specifically, the plurality of controllers 220 may delay the phases of the plurality of image signals sequentially so that the plurality of image signals may be output to the plurality of LED modules 110-1, . . . , 110-n at different timings.

The display driver 230 drives the plurality of display modules 210 under the control of the controller 220. For instance, the display driver 230 may drive each LED pixel by applying a driving voltage or driving current so as to drive each self-luminous lighting element, for example, LED pixels, constituting the plurality of display modules 210 under the control of the controller 220.

The display driver 230 comprises the plurality of LED driving modules 230-1, . . . , 230-n connected to each of the plurality of display modules 210. The plurality of driving modules 230-1, . . . , 230-n may transmit image signals received from the plurality of controllers 220 to each LED module so as to display images corresponding to the image signals on the screen of a display. Here, the LED driving module may be implemented as an LED driver.

In addition, the plurality of LED driving modules 230-1, . . . , 230-n supplies driving current to the plurality of display modules 210 so as to correspond to each image signal output from the controller 220, and drives the plurality of modules 210. Specifically, the plurality of LED driving modules 230-1, . . . , 230-n may output driving current supplied to the plurality of display modules 110-1, . . . , 110-n by adjusting the supply time and the intensity of the driving current so as to correspond to the respective image signals output from the controllers 220.

Each of the plurality of LED driving modules 230-1, . . . , 230-n may have a power supply for supplying power. The power supply may be a hardware that converts alternating current into direct current so that the current can be used stably in each of the plurality of display modules 210, providing the current to each system appropriately. The power supply may largely include an input electromagnetic interference filter section, an AC-DC rectification section, a DC-DC switching conversion section, an output filter, and an output section.

The image signals transmitted from the plurality of controllers 220 at different timings may be stored in a buffer connected to the plurality of LED driving modules 230-1, . . . ,230-n. Subsequently, each of the plurality of LED driving modules 230-1, . . . , 230-n may output frames corresponding to the received image signals to the display screen at the same time. In other words, the image signals may be stored in a buffer and thus, even if the controller 120 transmits the image signals to each of the plurality of LED modules 110-1, . . . ,110-n at different timings, the images corresponding to the image signals may be displayed by the display apparatus 100 at the same time.

Here, the power supply may be implemented, for example, as a switched mode power supply (SMPS). The SMPS is a DC stabilized power supply device that stabilizes the output by controlling the on-off time ratio of the semiconductor switch element, and may be used for driving each of the plurality of display modules 210 since it can be highly efficient, small and lightweight.

However, according to another embodiment, the display driver 230 may be implemented as a single driving module that may separately drive a plurality of SMPSs for supplying power to each of the plurality of display modules 210.

An image processing apparatus 300 may include an interface 310, a storage 320 and a processor 330. Here, the image processing apparatus 300 may be implemented as a sending box, a control box, a set-top box, and etc., which processes the input image signals and provide the processed image signals to the display apparatus 200.

The interface 310 may be connected to the display apparatus 200. Specifically, the interface 310 may be connected to the display apparatus 200 via a cable connected to a port. Here, the cable may be a High Definition Multimedia Interface (HDMI) cable. However, this is only an example, and the cable may be a Digital Visual Interface (DVI) cable, a Low Voltage Differential Signals (LVDS) cable or an optical cable.

In addition, the interface 310 may be connected to the display apparatus 200 via wireless communication. The interface 310 may include a Wi-Fi chip, a Bluetooth chip, a wireless communication chip, and etc.

The storage 320 may store various data necessary for the operations of the image processing apparatus 300. In particular, the storage 320 may store image data received from an external apparatus. Here, the external apparatus may be a server, a set-top box, a USB storage, PC, a smartphone, and etc.

The storage 320 may be implemented as a nonvolatile memory, a volatile memory, a hard disk drive (HDD) or a solid state drive (SSD), a memory card (e.g., a micro SD card, a USB memory, etc.) mounted in the image processing apparatus 300, an external memory (e.g., a USB memory, etc.) connectable to an external input port, etc.

The processor 330 may control the overall operations of the image processing apparatus 300.

Here, the processor 330 may include one or more of a central processing unit (CPU), a controller, an application processor (AP), a communication processor (CP), and an ARM processor.

In addition, the processor 330 may include a graphic processing unit for processing graphic corresponding to an image. The processor 330 may be implemented as System On Chip (SoC) including a core and a GPU. The processor 330 may include a single core, a dual core, a triple core, a quad core, and a multiple core thereof.

The processor 330 according to an embodiment may transmit the image inputted from an external apparatus to the display apparatus 200 through the interface 310. Specifically, the processor 330 may obtain a signal corresponding to each of the plurality of display modules 210 by processing the input image and provide the obtained signal to the plurality of controllers 220. Subsequently, the controller 220 may display an image corresponding to the signal on the display screen by controlling the plurality of display modules 210 and the display driver 230.

The image processing apparatus 300 is described as a separate apparatus from the display apparatus 200, but the image processing apparatus 300 may be included in the display apparatus 200 and implemented as a single apparatus.

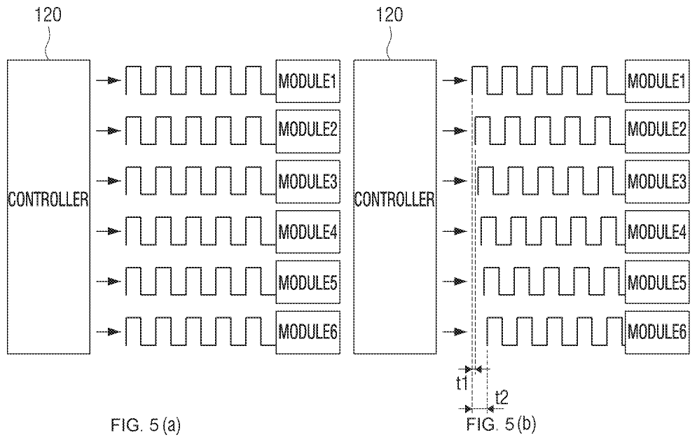

FIGS. 5(a) and 5(b) are schematic views illustrating a phase delay according to an embodiment.

In FIGS. 5(a) and 5(b), it is assumed that six LED modules form the display module 110. However, embodiments of the present disclosure are not limited thereto.

Specifically, FIG. 5(a) is a view illustrating an image signal in a frequency area before a phase is delayed.

Referring to FIG. 5(a), the controller 120 may output each of the first to the sixth image signals to the first to the sixth modules, respectively, at the same time. In other words, as the controller 120 outputs each of the plurality of image signals to the first to the sixth modules in a state where the phases of the plurality of image signals are not delayed, the peaks in the frequency area may be overlapped and the EMI may be increased.

FIG. 5(b) is a view illustrating an image signal in a frequency area after a phase is delayed.

FIG. 5(b) illustrates that the controller 120 may delay the phases of the plurality of image signals sequentially to output the plurality of image signals at different timings in a frequency area.

The controller 120 may delay the phases of image signals to be transmitted to each of the plurality of LED modules 110-1, . . . , 110-n sequentially by a predetermined time. Further, the controller 120 may sequentially delay a plurality of image signals by a predetermined time evenly.

Here, the predetermined time may be referred to as t1. For instance, the controller 120 may delay the second image signal such that the time for outputting image signals to the first LED module and the second LED module differs by t1, and delay the third image signal such that the time for outputting image signals to the second LED module and the third LED module also differs by t1. Furthermore, the controller 120 may delay image signals output to the remaining modules in the same manner.

Meanwhile, the controller 120 may delay the phases of a plurality of image signals sequentially, and the phase difference between the first image signal among a plurality of image signals and the last image signal among the plurality of image signals may fall within a time interval corresponding to a single frame. In other words, the controller may output the image signal which is output last within a time interval corresponding to a single frame.

Referring to FIG. 5(b), the controller 120 may delay the phases of a plurality of image signals sequentially so that t2 which is the phase difference between the image signal which is output for the first time from among the plurality of image signals and the image signal which is output for the last time is within the time interval corresponding to a single frame.

According to an embodiment, the controller 120 may set the phase difference t1 between a plurality of image signals to a value calculated by dividing the time corresponding to one frame by the number of the plurality of LED modules.

For instance, if the time corresponding to one frame is 60 ns and there are six LED modules forming the display module 110, the controller 120 may delay the phase of the image signal by setting the predetermined time to 10 ns which is calculated by dividing 60 ns by 6 (60 ns/6). In this case, t2 corresponding to the phase difference between the image signal which is output for the first time among a plurality of image signals and the image signal which is output for the last time, is equal to the time interval corresponding to one frame. Accordingly, the rising edges in the frequency area according to the transmission of image signals may be dispersed to the maximum, and the EMI can be reduced. If the time interval between the first image signal and the last image signal exceeds the time corresponding to one frame, there may be a problem that the frame corresponding to the image signal is overlapped with the next frame on the display screen.

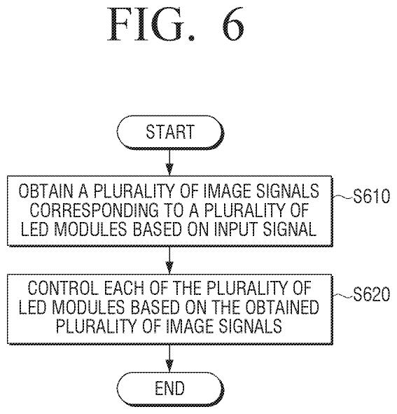

FIG. 6 is a flowchart provided to explain a controlling method of a display apparatus according to an embodiment.

The display apparatus may include the step of obtaining a plurality of image signals corresponding to a plurality of LED modules based on an input signal S610.

Here, the input signal may be a signal regarding input image information. In addition, the input image signals may be signals including at least one of a clock signal and a data signal. Here, the clock signal is a signal regarding time information for controlling the timing of displaying an image corresponding to a data signal, and may be output in the form of a spherical wave. The data signal may be a signal including data regarding an image to be displayed on the display apparatus 100. For instance, the data signal may include a pixel value, illuminance information and the like.

The display apparatus may include the step of controlling each of the plurality of LED modules based on the obtained plurality of image signals S620.

Specifically, the display apparatus may control the plurality of image signals to be output to the plurality of LED modules at different timings by delaying the phases of the plurality of image signals sequentially. The display apparatus may sequentially delay the phases of image signals to be transmitted to each of the plurality of LED modules by a predetermined time.

For example, if there is a display module including three LED modules, the display apparatus may output the first image signal to the first LED module, output the second image signal which is delayed by a predetermined time to the second LED module, and output the third image signal which is delayed by a predetermined time from the second image signal to the third LED module. Here, the predetermined time for the second image signal and the predetermined time for the third image signal may be the same or different.

The phase difference between the plurality of image signals may be obtained based on the time corresponding to one frame and the number of the plurality of LED modules. Specifically, the phase difference between the plurality of image signals may be a value which is calculated by dividing the time corresponding to one frame by the number of the plurality of LED modules. For instance, if the time corresponding to one frame is 30 ns and there are three LED modules forming the display module, the predetermined time may be 10 ns which is calculated by dividing 30 ns by 3 (30 ns/3). In other words, the display apparatus may transmit the first image signal to the first LED module and transmit the second image signal to the second LED module 10 ns later.

The display apparatus may delay the phases of a plurality of image signals sequentially, and the phase difference between the first image signal among the plurality of image signals and the last image signal among the plurality of image signals may be within a time interval corresponding to one frame.

The display apparatus may delay the phases of a plurality of image signals sequentially by a predetermined time based on an arrangement state of a plurality of LED modules.

According to an embodiment, the display apparatus may transmit the first image signal to the first LED module among the plurality of LED modules, and transmit the image signals having delayed phases in the order of the LED modules disposed at adjacent positions with reference to the first LED module.

According to another embodiment, the display apparatus may transmit the first image signal to the first LED module among the plurality of LED modules and transmit the second image signal which is delayed by a predetermined time, in comparison with the first image signal, to the second LED module which is disposed at the greatest distance from the first LED module.

When image signals are transmitted in the descending order of the distance, the peaks of the image signals may be further dispersed in the frequency area and thus, the EMI may be reduced further than the case where the image signals are transmitted sequentially between adjacent LED modules.

However, the present disclosure is not limited to the above-described embodiments, and the display may transmit image signals to LED modules in various ways, such as transmitting image signals of which phases are delayed in an arbitrary order.

Here, the plurality of LED modules may be modules including a plurality of Micro LED elements.

At least some of the methods according to the above-described various embodiments may be implemented with only software upgrades or hardware upgrades for the display apparatus consisting of the existing unit display modules and/or unit display modules.

Meanwhile, the above-described various embodiments may be embodied in a recording medium that may be read by a computer or a similar apparatus to the computer by using software, hardware, or a combination thereof. In some cases, the above-described embodiments may be implemented as a processor itself. In a software configuration, various embodiments described in the present disclosure, such as a procedure and a function, may be embodied as separate software modules. Each of the software modules may respectively perform one or more functions and operations described in the present disclosure.

Meanwhile, the computer instructions for performing the processing operations according to the above-described various embodiments may be stored in a non-transitory readable medium. The computer instructions stored in a non-transitory readable medium may cause a specific device to perform the processing operations according to the above-described various embodiments when executed by a processor.

The non-transitory readable recording medium does not refer to a medium that stores data for a short period of time, but may be a medium that stores data semi-permanently and is readable by a device. Specifically, the above-described various applications or programs may be stored in a non-transitory readable medium such as CD, DVD, hard disc, Blu-ray disc, USB, memory card, ROM, and etc.

While the present disclosure has been shown and described with reference to various embodiments thereof, it will be understood by those skilled in the art that various changes in form and details may be made therein without departing from the spirit and scope of the present disclosure. The modifications shall not be construed separately from the technical concept or prospect of the present disclosure.

What is claimed is:

1. A display apparatus comprising:
a plurality of Light Emitting Diode (LED) modules; and
a controller configured to obtain a plurality of image signals corresponding to the plurality of LED modules based on an input signal and control each of the plurality of LED modules based on the obtained plurality of image signals,
wherein the controller is configured to delay a phase of the plurality of image signals to control the plurality of image signals to be output to the plurality of LED modules at different timings.

2. The display apparatus as claimed in claim 1, wherein the controller is configured to delay the phase of the plurality of image signals sequentially, and a phase difference between a first image signal output among the plurality of image signals and a last image signal output among the plurality of image signals is within a time interval corresponding to one frame.

3. The display apparatus as claimed in claim 1, wherein the plurality of image signals comprise at least one of a clock signal and a data signal.

4. The display apparatus as claimed in claim 1, wherein a phase difference between the plurality of image signals is obtained based on a time corresponding to one frame and a number of the plurality of LED modules.

5. The display apparatus as claimed in claim 1, wherein the controller is further configured to delay the phase of the plurality of image signals sequentially by a predetermined time based on an arrangement state of the plurality of LED modules.

6. The display apparatus as claimed in claim 5, wherein the controller is further configured to transmit a first image signal to a first LED module among the plurality of LED modules, and transmit a second image signal that is delayed by the predetermined time from the first image signal, to a second LED module that is arranged at a greatest distance from the first LED module.

7. The display apparatus as claimed in claim 1, wherein the plurality of LED modules comprise a plurality of Micro LED elements.

8. A display system comprising:
a display apparatus comprising a plurality of display modules including a plurality of LED modules, and a plurality of controllers connected to the plurality of display modules; and
an image processing apparatus configured to obtain a plurality of image signals corresponding to the plurality of display modules by processing an input image signal, and transmit the obtained signal to the plurality of controllers,
wherein each of the plurality of controllers is configured to receive, from the image processing apparatus, the plurality of image signals corresponding to each of the plurality of LED modules, and control each of the plurality of LED modules based on the received plurality of image signals.

9. The display system as claimed in claim 8, wherein each of the plurality of LED modules comprise a plurality of Micro LED elements, and
wherein the plurality of LED modules are connected to form at least one of the plurality of display modules.

10. A controlling method of a display apparatus, the method comprising:
obtaining a plurality of image signals corresponding to a plurality of LED modules based on an input signal; and
controlling each of the plurality of LED modules based on the obtained plurality of image signals,
wherein the controlling comprises delaying a phase of the plurality of image signals to control the plurality of image signals to be output to the plurality of LED modules at different timings.

11. The method as claimed in claim 10, wherein the controlling comprises delaying the phase of the plurality of image signals sequentially, and a phase difference between a first image signal output among the plurality of image signals and a last image signal output among the plurality of image signals is within a time interval corresponding to one frame.

12. The method as claimed in claim 10, wherein the plurality of image signals comprise at least one of a clock signal and a data signal.

13. The method as claimed in claim 10, wherein a phase difference between the plurality of image signals is obtained based on a time corresponding to one frame and a number of the plurality of LED modules.

14. The method as claimed in claim 10, wherein the controlling further comprises delaying the phase of the plurality of image signals sequentially by a predetermined time based on an arrangement state of the plurality of LED modules.

15. The method as claimed in claim 14, wherein the controlling further comprises transmitting a first image signal to a first LED module among the plurality of LED modules, and transmitting a second image signal that is delayed by the predetermined time from the first image signal, to a second LED module that is arranged at a greatest distance from the first LED module.

16. The method as claimed in claim 10, wherein the plurality of LED modules comprise a plurality of Micro LED elements.
